(19) United States
(12) Patent Application Publication
(10) Pub. No.: US 2019/0316938 A1
(43) Pub. Date: Oct. 17, 2019

(54) Tilt-Tolerant Linear Displacement Sensor

(71) Applicant: Robert Bosch GmbH, Stuttgart (DE)

(72) Inventors: Ingo Herrmann, Friolzheim (DE); Fabian Utermoehlen, Leonberg (DE)

(21) Appl. No.: 16/303,035

(22) PCT Filed: May 4, 2017
(86) PCT No.: PCT/EP2017/060594

§ 371 Date: Nov. 19, 2018

(30) Foreign Application Priority Data
May 19, 2016 (DE) 10 2016 208 644.8

(51) Int. Cl. G01D 5/244; G01B 7/02; G01D 5/20

(52) U.S. Cl. CPC G01D 5/24485; B62K 25/06; G01D 5/202; G01B 7/023

(57) ABSTRACT

A linear displacement sensor includes an induction element, measuring sensor element, and correction sensor element. The induction element has a first side with an electrically conductive measuring track running along a measurement path. The measuring sensor element is positioned over the first side, is movable relative to the induction element along the path, and includes a measuring coil positioned over the measuring track such that an overlap between the measuring coil and the measuring track changes along the path so that an induction of the measuring coil is dependent on a position of the measuring coil on the path. A second side of the induction element has an electrically conductive correction track running along the path. The correction sensor element is rigidly connected to the measuring sensor element, is positioned over the second side, and has a correction coil with a constant overlap with the correction track along the path.

### FIELD OF THE INVENTION

The invention relates to a linear displacement sensor and a method for determining a relative position with this linear displacement sensor.

### PRIOR ART

Sensors based on the eddy current principle are already known. The measuring signal can be a change in frequency of an oscillator circuit, which comprises a measuring coil that is arranged above an electrically conductive track. The electrically conductive track changes in width along the measurement path in such a way that a degree of coverage of the measuring coil by the electrically conductive measuring track changes along the measurement path. The measuring coil induces an eddy current in the conductive track, which leads to an inductance change in the measuring coil.

Such a sensor is disclosed, for example, in DE 10 2004 033 083 A1.

A tolerance-robust design normally requires the use of a plurality of sensor coils and a plurality of conductive tracks, which usually have an identical geometry, but are offset relative to each other along the periphery of the object to be measured.

In addition to the movement in the measuring direction (such as a rotation about an x-axis), due to tolerances a displacement and distance changes may occur between the measuring coil and the electrically conductive measuring track (i.e. to a movement in the x-direction and the z-direction). Furthermore, a tilting about the y-axis is possible. A tilting and a change in distance can be particularly critical for the measuring procedure, because the eddy current effect is strongly distance dependent.

### DISCLOSURE OF THE INVENTION

### Advantages of the Invention

Embodiments of the present invention can enable, in an advantageous manner, a displacement sensor to be provided which is robust to tolerances and which requires a particularly small installation space.

Ideas for embodiments of the present invention can be considered to be based, among other things, on the ideas and insights as described below.

One aspect of the invention relates to a linear displacement sensor. A linear displacement sensor can be a device which is configured to determine a relative distance between or a relative position of two components. For example, the linear displacement sensor can be used for measuring the depth of deflection of a motorcycle, or of a motorcycle suspension fork. Also, the linear displacement sensor can be used, for example, to detect the position of a brake pedal or the gear position of an automatic transmission.

According to one embodiment of the invention, the linear displacement sensor comprises an induction element, which on a first side has an electrically conductive measuring track which runs along a measurement path; and a measuring sensor element, which is arranged over the first side of the induction element and is movable relative to the induction element along the measurement path, wherein the measuring sensor element comprises a measuring coil which is arranged over the measuring track and wherein an overlap between the measuring coil and the measuring track changes along the measurement path in such a manner that an induction of the measuring coil is dependent on a position of the measuring coil on the measurement path. In other words, the linear displacement sensor is based on the eddy current principle. The inductance of the measuring coil depends on its position over the measuring track. If the measuring coil is at a position over the measuring coil at which the overlap between the measuring coil and the measuring track is greater, the induction is higher than at a position where the overlap is small. The measuring coil together with a capacitor can form a resonant circuit, the resonance frequency of which therefore depends on the position of the measuring coil. The frequency of an alternating voltage excited in the measuring coil can be measured, and from this the position can be derived.

The linear sensor further comprises a correction sensor element, which is rigidly connected to the measuring sensor element and which is arranged over a second side of the induction element, wherein on the second side the induction element has at least one electrically conductive correction track running along the measurement path and the correction sensor element has at least one correction coil, the degree of overlap of which with the correction track is constant along the measurement path. In order to compensate for any tilting and/or displacement orthogonal to the measurement path of the induction element relative to the measuring sensor element, the linear sensor additionally has at least one correction coil, which similarly to the measuring coil is arranged over a correction track and also works according to the eddy current principle. In contrast to the measuring track, however, the correction coil and the correction track have a uniform overlap along the measurement path, so that using the at least one correction coil at least one distance can be determined between the correction sensor element and the induction element, and therefore between the measuring sensor element and the induction element. This distance can be fed into the calculation of the position of the measuring sensor element relative to the induction element to make this calculation more accurate.

In order to save installation space, the measuring track and the at least one correction track are arranged on different, for example opposite, sides of the induction element. The at least one correction coil can also be located on its own correction sensor element, opposite the measuring sensor element. Thus, the induction element can be received between the measuring sensor element and the correction sensor element. The induction element is structured on two sides, so that it can be narrower than if all tracks were arranged on one side. This enables installation with smaller space requirements.

For example, the linear displacement sensor can be installed in the inside of a tube, wherein the measuring sensor element and the correction sensor element are attached on opposite inner sides of the tube.

Overall, the linear displacement sensor allows a significantly reduced installation space, wherein a reduction in the width by up to a factor of three is possible, compared to a linear displacement sensor with tracks arranged side by side.

Since the linear displacement sensor is tolerance-robust, this enables a less expensive construction and connection technology to be used. The simple measuring principle is also robust against electromagnetic interference.

According to one embodiment of the invention, the induction element comprises a printed circuit board, on which on the first side the measuring track and on the second side the at least one correction track are arranged as conductor tracks. The induction element can therefore be a two-layer printed circuit board. The measuring track and the one or more correction tracks can be provided as metal layers on the printed circuit board.

According to one embodiment of the invention the measuring sensor element comprises a printed circuit board on which the measuring coil is configured as a planar coil, and/or the correction sensor element comprises a printed circuit board on which the at least one correction coil is configured as a planar coil. The measuring coil and the one, two or more correction coils can be integrated into two printed circuit boards, between which the induction element extends. The measuring coil and/or the at least one correction coil can be implemented from conductor tracks on and/or in a printed circuit board.

According to one embodiment of the invention, the induction element has two correction tracks arranged next to each other on the second side and the correction sensor element has two correction coils arranged next to each other. With two or more correction coils it is possible to detect a tilting of the induction element relative to the correction sensor element. Since the correction sensor element is rigidly connected to the measuring sensor element (i.e. the two sensor elements are fixed in such a way that they are immovable relative to each other), from this tilting a tilting of the induction element relative to the measuring sensor element can also be determined.

According to one embodiment of the invention, the correction coils have a smaller width than the measuring coil. The measuring coil and the correction coil can be designed in the same way. However, in order to save space, the at least one correction coil can be made narrower than the measuring coil. The term width in this case can be understood to mean an extent in a direction orthogonal to the measurement path in the plane of the respective measuring sensor element or correction sensor element.

According to one embodiment of the invention the measuring coil, the measuring track, the at least one correction track and the at least one correction coil overlap with respect to a direction orthogonal to the induction element. In particular, the measuring track and the at least one correction track can be arranged in the same area of the induction element and/or overlap each other.

According to one embodiment of the invention the measuring track tapers along the measurement path. The measuring track can have two edges which converge towards each other in the measuring direction. For example, the measuring track can be triangular or trapezoidal in shape. Conversely, a correction track can have two edges which run parallel to the measurement direction. For example, a correction track can be rectangular.

According to one embodiment of the invention, the measuring track has a minimum width of 20% of the width of the measuring coil along the measurement path. With a measuring track which overlaps at least 20% of the measuring coil over the entire measurement path, in particular in the case of a planar coil, an essentially linear signal is obtained which, for example, can be evaluated more easily.

According to one embodiment of the invention, the at least one correction track has a constant width along the measurement path. For example, the at least one correction track can have a width of less than 50% of the width of a correction coil. This ensures that even larger lateral displacements to not give rise to a substantial change in the signals of the one or more correction coils, and essentially only one distance measurement is performed.

According to one embodiment of the invention, the at least one correction track is offset with respect to a center of the corresponding correction coil. In the case of a spiral-shaped planar coil, the outer conductors contribute more to the inductance than the inner conductors. In particular in the case of a correction coil configured as a planar coil, with an asymmetrically arranged correction track the resulting effect is that a distance change gives rise to larger inductance changes and thus to larger changes in the measured signal.

A further aspect of the invention relates to a method for determining a relative position of a measuring sensor element and of an induction element of a linear displacement sensor, as is described above and below. For example, the method can be implemented by a controller which can be arranged on the measuring sensor element and/or the correction sensor element, for example on the associated printed circuit boards in addition to the measuring coil and the at least one correction coil.

According to one embodiment of the invention, the method comprises: energizing the measuring coil and the at least one correction coil, in each case with an alternating voltage, the frequency of which is dependent on an induction of the measuring coil and the at least one correction coil with the induction element. For example, an alternating voltage can be applied to the measuring coil and the one or more correction coils, which voltage induces an eddy current in the measuring track and the one or more correction tracks, and which therefore changes the inductance of the respective coil (measuring coil or correction coil). The coils can each be connected to a resonant circuit, the frequency of which changes with the respective inductance value. This frequency can be evaluated as a measurement signal for the respective coil.

According to one embodiment of the invention, the method further comprises: measuring at least one correction frequency signal of the at least one correction coil; determining at least one distance from the at least one correction coil to the induction element from the respective correction frequency signal; measuring a measuring frequency signal of the measuring coil; correcting the measuring frequency signal based on the at least one determined distance of the correction coil; and determining the relative position from the corrected measuring frequency signal. From the correction frequency signal or signals, the distances of the respective correction coil from the associated track can be calculated using a table or a formula. From the measuring frequency signal, also based on a table or a formula, a current position of the linear displacement sensor can be calculated, the previously determined distances being fed into this calculation.

An algorithm which implements the method and can be implemented in the control system as a computer program, requires little computing power and can be implemented with a standard micro-controller.

### BRIEF DESCRIPTION OF THE DRAWINGS

In the following, embodiments of the invention are described with reference to the attached drawings, where neither the drawings nor the description are to be interpreted as restricting the invention.

FIGS. 1A, 1B and 1C schematically show a linear displacement sensor according to an embodiment of the invention, wherein FIG. 1A shows a cross section, FIG. 1B a plan view and FIG. 1C a view from below.

FIG. 2 shows a schematic plan view of a planar coil.

FIGS. 3A, 3B and 3C schematically show a linear displacement sensor according to an embodiment of the invention, wherein FIG. 3A shows a cross section, FIG. 3B a plan view and FIG. 3C a view from below.

FIG. 4 shows a graph illustrating a dependency of a frequency on a distance between an induction element and a coil.

FIG. 5A shows a schematic of a cross section through the linear displacement sensor from FIGS. 2A to 2C in a normal position.

FIG. 5B shows a graph of measurement signals for the position shown in FIG. 5A.

FIG. 6A shows a schematic of a cross section through the linear displacement sensor from FIGS. 2A to 2C in a displaced position.

FIG. 6B shows a graph of measurement signals for the position shown in FIG. 6A.

FIG. 7A shows a schematic of a cross section through the linear displacement sensor from FIGS. 2A to 2C in a tilted position.

FIG. 7B shows a graph of measurement signals for the position shown in FIG. 7A.

The figures are only schematic and not drawn to scale. Identical reference numerals in the figures refer to the same or equivalent features.

### EMBODIMENTS OF THE INVENTION

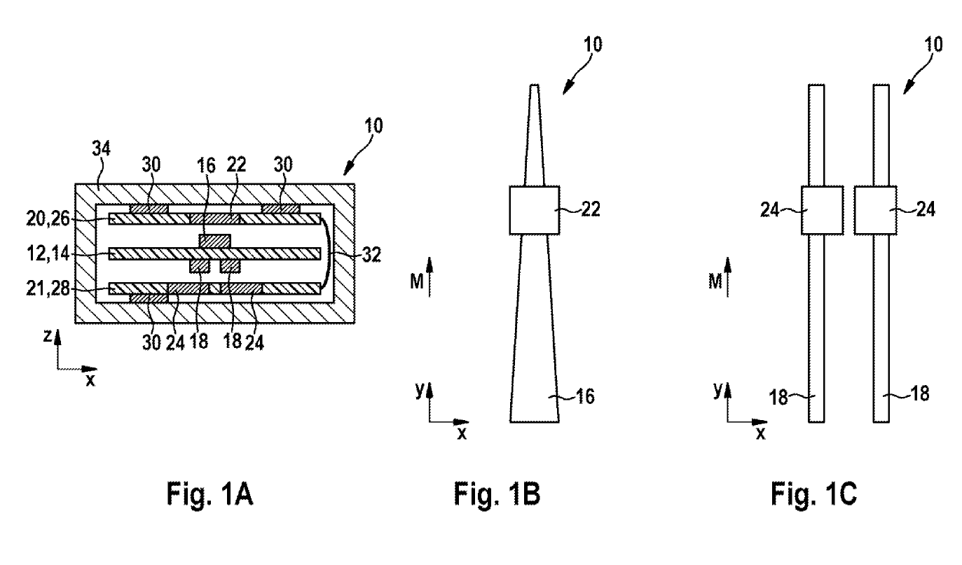

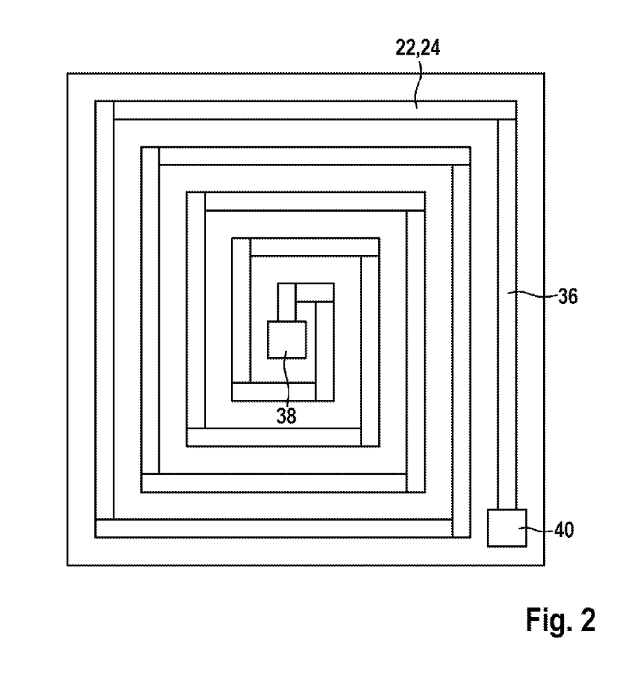

FIG. 1A shows a schematic cross section, FIG. 1B shows a schematic plan view and FIG. 1C shows a schematic view from below of a linear displacement sensor 10. As is apparent in FIG. 1A, the linear displacement sensor 10 comprises an induction element 12 in the form of a printed circuit board 14, on which on one side a measuring track 16 and on an opposite side two correction tracks 18 are mounted. The measuring track 16 and the correction tracks 18 can be configured as metallization layers on a plastic substrate of the printed circuit board 14.

The correction tracks 18 and the measuring track 16 are arranged on different sides of the induction element 12. Opposite the measuring track 16, a measuring coil is arranged on a measuring sensor element 20. In addition, opposite each correction track 18 one correction coil 24 is arranged on each correction sensor element 21. The measuring coil 22 and the correction coils 24 can be configured as one or more conductor tracks on a plastic substrate of a measuring sensor printed circuit board 26 or of a correction sensor printed circuit board 28. The measuring coil 22 and the correction coils 24 can be planar coils and/or can be arranged in a plurality of layers of the respective printed circuit board 26, 28. The correction coils 24 and the measuring coils 22, which can have an identical geometry, can be arranged on opposite sides of the printed circuit boards 26, 28.

The measuring sensor element 20 or the printed circuit board 26 and/or the correction sensor element 21 or the printed circuit board 28 can carry components of a control/evaluation electronics 30, which can supply the coils 22, 24 with alternating voltage and/or which can also carry out the evaluations for the position determination, as described in more detail below. The evaluation electronics 30 can either be distributed over the two printed circuit boards 26, 28, or be located on only one of the two, or on a third printed circuit board. In addition, the two printed circuit boards 26, 28 can be electrically connected to each other, for example via a flex cable 32.

The measuring sensor element 20 and the correction sensor element 21 are rigidly mechanically connected to each other and/or may be mounted on opposite inner sides of a tube 34 (which belongs, for example, to a motorcycle suspension fork). The induction element 12 is moveable in the direction of a measured value M (see FIGS. 1B and 1C) between the two sensor elements 20, 21.

FIGS. 1A, 1B and 1C show mutually orthogonal directions x, y, z, wherein the measurement path M extends in the y direction, x is a width direction and z is a distance direction (with respect to the elements 12, 20, 21 or the printed circuit boards 14, 26, 28).

In FIG. 1B, only the measuring track 16 and the measuring coil 22 are shown, the measuring track 16 and the measuring coil 22 are moveable with respect to each other in the measuring direction in order to enable determination of the position y. The overlap between the measuring coil 22 and the measuring track 16 is dependent on the position y. The measuring track 16 has two edges that are straight, but extending at an angle to the measurement path M, so that the overlap depends substantially linearly on the position y. The measuring track 16 can be shaped like a triangle, the base of which is oriented perpendicular to the measuring direction. The base can have dimensions which are approximately equal to the width of the measuring coil 22 (a few mm to a few cm). The height of the triangle can be equal to the measurement path M (a few cm up to a few tens of cm).

The induction element 12 and the measuring sensor element 20 can be oriented to each other such that in any position y a central axis of the measuring track 16 is coincident with the central axis of the measuring coil 22 along the measurement direction M. The measuring track 16 can be arranged, for example, centrally with respect to the measuring coil 22.

It is also possible for the measuring track 16 to be configured as a trapezium. This can have the advantage that a more linear measuring signal is obtained. This is due to the fact that an overlap by a very narrow tip of a triangle can have almost no effect on the inductance of the measuring coil 22 and therefore can cause virtually no change in frequency. The measuring track 16 can have a certain minimum width, for example 20% of the width of the measuring coil 22 (in the x-direction).

FIG. 1C shows only the correction tracks 18 and the measuring coils 24, which are located on the other side of the printed circuit board 14 than the components 16 and 22. The one, two or more correction tracks 18 have a geometry that does not vary with the measurement path M, the overlap of which with the associated correction track is therefore independent of the position on the measurement path M.

The correction tracks 18 can be rectangles which are narrower in their width than the corresponding correction coils 24, and have, for example, a width of 50% of the width of the corresponding compensation coil 24. The correction coils 24 can be oriented asymmetrically in relation to the correction tracks in the x-direction. In other words, a central axis of a correction track 18 is arranged offset with respect to a central axis of the corresponding correction coil 24. This arrangement allows a better correction to be obtained for lateral displacements (in the x-direction) of induction element 12 and sensor elements 20, 21.

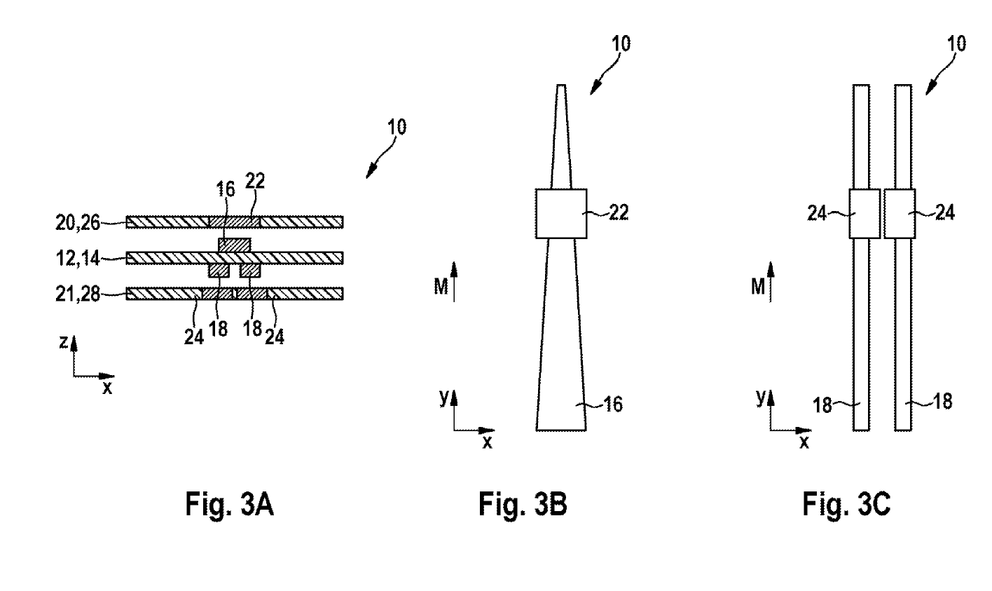

This can be understood from FIG. 3, which shows a planar coil 22, 24. The measuring coil 22 and each of the correction coils 24 can be shaped like the planar coil shown in FIG. 3 and/or be implemented in one or more layers of the printed circuit board 26, 28. The planar coil 22, 24 has a conductor 36 lying in a plane (defined by the x- and y-direction), which extends in a spiral shape from an inner connection 38 to an outer connection 40.

The better correction mentioned above can then be attributed to the fact that an outer section of the conductor 36 of the planar coil 22, 24 can contribute more to the inductance of the planar coil 22, 24 than an inner section of the conductor 36 (relative to the centrally positioned connection 38). A horizontal displacement of an asymmetrically aligned correction track 18 can therefore give rise to a larger inductance change, hence to a larger frequency change and hence to a better correction.

In a similar way to FIGS. 1A to 1C, FIGS. 3A to 3C show a further embodiment of a linear displacement sensor 10, which can have a smaller width than the linear displacement sensor 10 shown in FIGS. 1A to 1C. This is implemented by the correction coils 18 being designed narrower than the measuring coil 22. As is apparent in FIG. 3A, the correction coils 18 can adjoin each other in the width direction x and/or in each case have a width only slightly more than 50% of the width of the measuring coil 22 (such as less than 60% of the width of the measuring coil 22).

The measuring principle of the linear displacement sensor is based on an eddy current effect. The controller 30 generates an alternating voltage in the coils 22, 24, which generates an eddy current in the tracks 16, 18, resulting in an inductance change in the coil 22, 24. If an alternating voltage is applied to the detection coil 22, 24, an electromagnetic alternating field is produced, which induces an eddy current in the track 16, 18. This generates a field in the opposite direction to the first field, resulting in a reduced inductance of the coil 22, 24. If the coil 22, 24 is wired into an electrical resonant circuit (which is integrated in the controller 39, for example), this induces a change in the resonant frequency of the same in accordance with

$${f}_{o} = \frac{1}{2 π \sqrt{LC}}$$

The more the measuring coil 22 is overlapped by the measuring track 16 and/or the closer a coil 22, 24 approaches the track 16, 18, the higher the frequency of the oscillator circuit becomes. If the distance in the z-direction between the measuring coil 22 and the measuring track 16 is held constant, and the measuring track 16 is structured, a change in the position of the measuring coil 22 along the measurement path M will result in a change in frequency. Measuring the frequency, for example by counting or using a lock-in method, therefore allows the position y to be deduced. The capacitors used in the resonant circuit can be selected so that a frequency in the range of several tens of MHz is obtained.

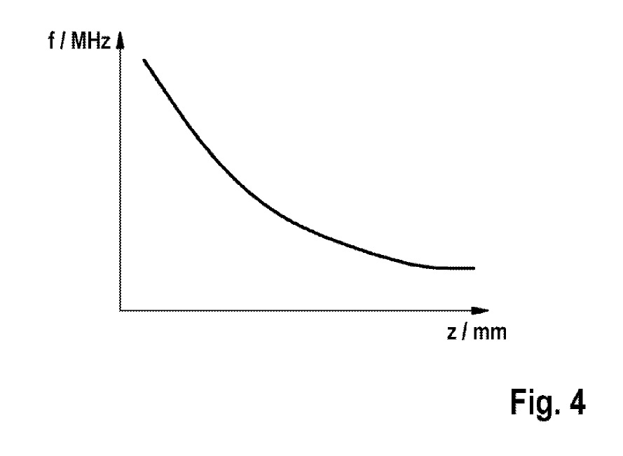

If a change in distance occurs between the measuring coil 22 and the measuring track 16, this leads to measurement errors which can be corrected with one or more pairs consisting of a correction coil 24 and a correction track 18. For example, FIG. 4 shows the dependence of the resonance frequency f of a resonant circuit, consisting of a coil 22, 24 and a capacitor, as a function of the distance z between the coil 22, 24 and the associated track 16, 18.

This relationship can be stored in the controller 30 as calibration data for each coil 22, 24. These data can be determined prior to the use of the linear displacement sensor 10, and/or in particular describe how the frequency f behaves as a function of the distance z between the coil 22, 24 and the corresponding track 16, 18. The calibration data can be stored, for example, in the memory of the controller, for example of an ASIC or microcontroller, either in the form of a look-up table or in analytical form, i.e. as a coded function.

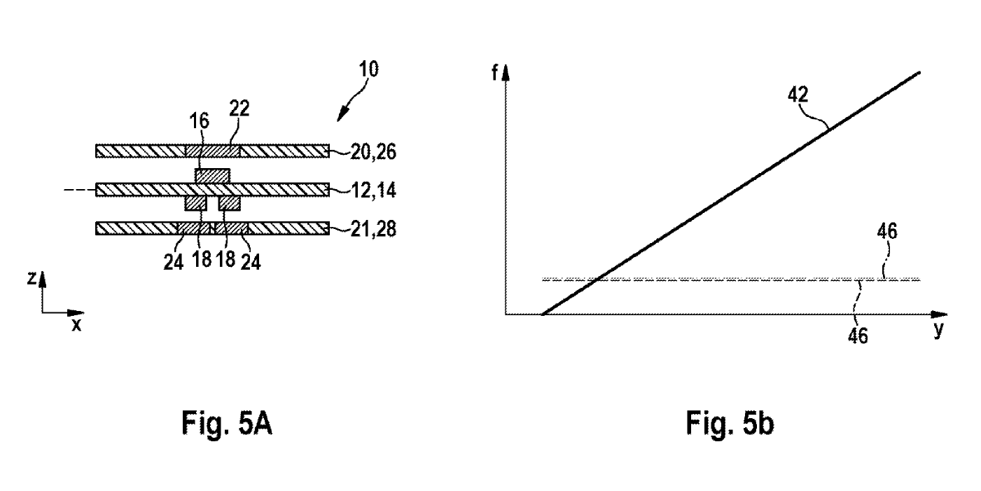

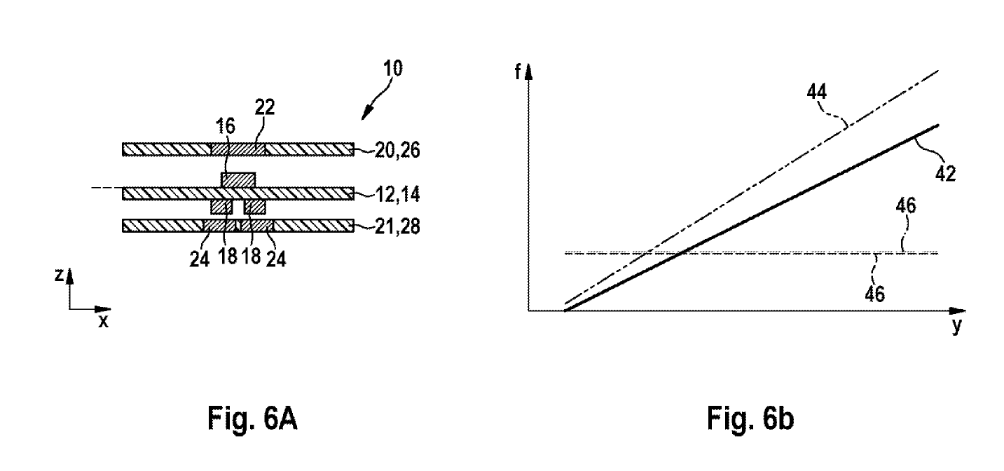

The correction of the measuring frequency signal is illustrated with reference to the following figures, wherein FIGS. 5A, 6A and 6C show the linear displacement sensor 10 in various tolerance values. The corresponding FIGS. 6A, 6B and 6C are graphs showing a measuring frequency signal 42, a corrected measuring frequency signal 44 and correction frequency signals 46 as a function of the measuring path position y.

The controller 30 can measure the correction frequency signals 46 of the correction coils 24 and then, using the calibration data, determine a distance z of the respective correction coil 24 from the induction element 12 from the respective correction frequency signal 46. From geometric data of the linear displacement sensor 10, also stored in the controller 30, the controller 30 can then calculate a position of the measuring coil 22 in relation to the induction element 12 from the distances between the correction coils 24. In addition, the controller 30 can measure a measuring frequency signal 42 of the measuring coil 22 and correct the measuring frequency signal 42 based on the determined distances of the correction coils 24. From the corrected measuring frequency signal 44 the relative position y of the induction element 12 and the sensor elements 20, 21 can then be determined.

FIG. 5A shows the linear displacement sensor 10 in a normal position, i.e., the induction element 12 is neither displaced nor tilted compared to an initial state. Without tolerances the measuring frequency signal 42 (frequency of the resonant circuit with the measuring coil) behaves as a linear function of the measuring position y. Since the induction element 12 is not tilted, the correction frequency signals 46 are almost identical and no correction needs to be made. The dashed line to the left of the induction element 12 designates the initial position of the induction element 12.

FIG. 6A shows the linear displacement sensor 10 in a position displaced in the distance direction z. If, for example, the induction element 12 moves in the direction of the correction sensor element 21, the measuring frequency signal 42 decreases due to the greater distance between the measuring coil 22 and the measuring track 16. At the same time, the correction frequency signals 46 both become larger by the same amount. A corrected measuring frequency signal 44 is calculated as shown, based on the stored calibration data.

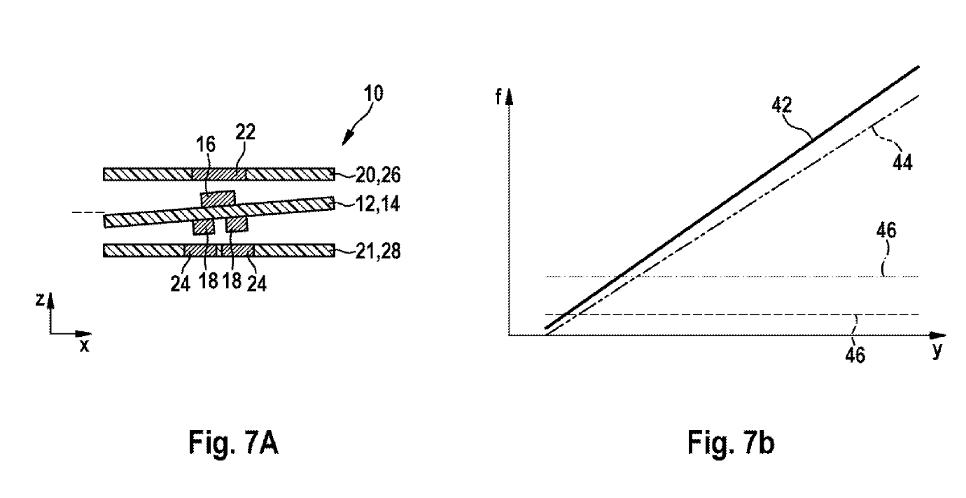

FIG. 7A shows the linear displacement sensor 10 in a position tilted about the y-direction. If the mean distance of the induction element 12 relative to the sensor elements 20, 21 remains constant while a tilting movement occurs, the one correction frequency signal 46 becomes larger and the other correction frequency signal 46 becomes smaller. (The closer the correction track 18 is to the correction coil 24, the greater the correction frequency signal 46 will be.)

Due to the non-linear relationship between distance and frequency (see FIG. 4), a tilting movement leads to high frequencies in the measuring frequency signal 42. Again, a corrected measuring frequency signal 44 can be calculated based on the calibration data.

Further positions of the induction element are obtained from combinations of the cases described above. In particular, the linear displacement sensor 10 or the correction algorithms can correct not only static tolerances (i.e., for example, a static tilting), but also dynamic tolerances.

It is noted in conclusion that terms such as “having”, “comprising”, etc. do not exclude any other elements or steps, and terms such as “a” or “an” do not exclude a plurality. Reference numerals in the claims are not to be regarded as restrictive.

1. A linear displacement sensor, comprising:
an induction element, including:
a first side having an electrically conductive measuring track that runs along a measurement path; and
a second side having at least one electrically conductive correction track that runs along the measurement path;
a measuring sensor element that is positioned over the first side of the induction element, that is movable relative to the induction element along the measurement path, and that includes a measuring coil positioned over the measuring track such that an overlap between the measuring coil and the measuring track changes along the measurement path so that an induction of the measuring coil is dependent on a position of the measuring coil on the measurement path; and
a correction sensor element that is connected rigidly to the measuring sensor element, that is positioned over the second side of the induction element, and that includes at least one correction coil having an overlap with the at least one correction track that is constant along the measurement path.

2. The linear displacement sensor as claimed in claim 1, wherein:
the induction element further includes a printed circuit board; and
the measuring track and the at least one correction track are conductor tracks on the printed circuit board.

3. The linear displacement sensor as claimed in claim 1, wherein:
at least one of the measuring sensor element and the correction sensor element further includes a printed circuit board; and
the at least one measuring coil is configured as a planar coil on the printed circuit board.

4. The linear displacement sensor as claimed in the claim 1,
wherein the induction element includes two correction tracks positioned next to each other on the second side; and
wherein the correction sensor element includes two correction coils positioned next to each other.

5. The linear displacement sensor as claimed in claim 1, wherein the at least one correction coil has a lower width than the measuring coil.

6. The linear displacement sensor as claimed in claim 1, wherein the measuring coil, the measuring track, the at least one correction track and the at least one correction coil overlap in a viewing direction orthogonal to the induction element.

7. The linear displacement sensor as claimed in claim 1, wherein at least one of:
the measuring track tapers along the measurement path; and
the measurement track has a minimum width along the measurement path of 20% of the width of the measuring coil.

8. The linear displacement sensor as claimed in claim 1, wherein at least one of the at least one correction track has a constant width along the measurement path; and
the at least one correction track has a width of less than 50% of the width of a correction coil.

9. The linear displacement sensor as claimed in claim 1, wherein the at least one correction track is positioned offset relative to a center of the at least one correction coil.

10. A method for determining a relative position of a measuring sensor element and an induction element of a linear displacement sensor, the method comprising:
energizing a measuring coil of a measuring sensor element of a linear displacement sensor and at least one correction coil of a correction sensor element of the linear displacement sensor with an alternating voltage having a frequency dependent on an induction of the measuring coil and the at least one correction coil with an induction element, wherein:
the induction element includes a first side having an electrically conductive measuring track that runs along a measurement path, and a second side having at least one electrically conductive correction track that runs along the measurement path;
the measuring sensor element is positioned over the first side of the induction element, and is movable relative to the induction element along the measurement path;
the measuring coil is positioned over the measuring track such that an overlap between the measuring coil and the measuring track changes along the measurement path so that an induction of the measuring coil is dependent on a position of the measuring coil on the measurement path;
the correction sensor element is connected rigidly to the measuring sensor element, and is positioned over the second side of the induction element; and
the at least one correction coil has an overlap with the at least one correction track that is constant along the measurement path;
measuring at least one correction frequency signal of the at least one correction coil;
determining at least one distance from the at least one correction coil to the induction element with reference to the at least one correction frequency signal;
measuring a measuring frequency signal of the measuring coil;
correcting the measuring frequency signal with reference to the at least one determined distance of the at least one correction coil; and
determining a relative position of the measuring sensor element and the induction element with reference to the corrected measuring frequency signal.
